(19) United States
(12) Patent Application Publication
(10) Pub. No.: US 2014/0068018 A1
(43) Pub. Date: Mar. 6, 2014

(54) CONTENT SYNCHRONIZATION APPARATUS AND METHOD FOR CLOUD SERVICE SYSTEM

(71) Applicant: Samsung Electronics Co., Ltd., Gyeonggi-do (KR)

(72) Inventors: Gookpil ROH, Jeollanam-do (KR); Dukkyoo KIM, Seoul (KR)

(73) Assignee: Samsung Electronics Co., Ltd., Gyeonggi-do (KR)

(21) Appl. No.: 14/014,687

(22) Filed: Aug. 30, 2013

(30) Foreign Application Priority Data
Aug. 30, 2012 (KR) 10-2012-0095881

(51) Int. Cl. H04L 29/08

(52) U.S. Cl. CPC H04L 67/1095
USPC 709/219

(57) ABSTRACT

A method and apparatus for synchronization of contents in a cloud service system for a mobile environment is provided. The synchronization method of a cloud service system includes uploading, at a device when data is changed, the changed data to a server, processing, at the server, the uploaded data, storing, at the server, the processed data along with a time change, transmitting, at the device, a synchronization request signal including a most recent server connection time at a predetermined time, downloading, at the device, a data log on data changed between the most recent server connection time and the current time, synchronizing, at the device, the data based on the data log, and updating the most recent server connection time.

### PRIORITY

This application claims priority under 35 U.S.C. §119(a) to a Korean Patent Application filed on Aug. 30, 2012 in the Korean Intellectual Property Office and assigned Serial No. 10-2012-0095881, the entire disclosure of which is incorporated herein by reference.

### BACKGROUND

1. Field of the Invention

The present invention generally relates to a content synchronization apparatus and method for a cloud system and, more particularly, to a method and apparatus for synchronization of contents in the cloud service system for a mobile environment.

2. Description of the Related Art

Typically, a cloud service is a service for storing user media files such as movie, photo, and audio files, documents, and address books in a remote server and allowing a user to download the remotely stored files by means of a device such as smartphone and a smart TV. Recently, there has been a tendency to use Personal Cloud Computing (PCC) services. This cloud service is transparent to Operating Systems (OS) and device platforms and allows the user to store various contents (photos, motion pictures, games, mail, documents, etc.) in an Internet server and access the contents by means of various Information Technology (IT) devices, i.e. clients (including smartphones, tablet PCs, ebook readers, Internet Protocol Television (IPTV), etc.

The cloud service system is provided under the assumption that all the contents are synchronized among all the clients. The conventional cloud service system aims to maximize the extensity of the cloud server and, in order to accomplish this, is designed in a way to minimize the load at the cloud server. In the conventional cloud service system, the content synchronization operation (which is a CPU-driven operation) is performed by the client. Accordingly, the conventional client compares the local files and the corresponding files stored in the server to check the most recent version of the file and determine whether to download or upload the corresponding files. According to the content modification characteristic of the terminal, all the events of creation, modification, and deletion are reflected to plural devices owned by the same user.

However, it is difficult to apply the conventional content synchronization method to the cloud service system in the mobile environment. This is because most mobile devices (i.e. clients) are powered by batteries, and thus content synchronization is restricted by battery capacity and CPU power. Accordingly, the CPU-driven operation task performed by the client significantly increases the battery consumption of the client device.

In the cloud system, since all the events (creation, modification, and deletion) are reflected to the system, the synchronization operation may occur unnecessarily. For example, if a content item is created or modified and then deleted immediately, it may not cause any problem to ignore the event occurred before the deletion. If such unnecessary synchronization operations occur, this causes unnecessary battery consumption.

### SUMMARY

Accordingly, an aspect of the present invention provides a content synchronization apparatus and method that is capable of reducing the client device operations by allowing the cloud server to perform the content synchronization function in the cloud service system.

Another aspect of the present invention provides a content synchronization apparatus and method that is capable of minimizing an amount of data transmission by managing and compacting the data synchronization history between the server and the client efficiently in the cloud service system.

In accordance with an aspect of the present invention, a synchronization method of a cloud service system is provided. The method includes uploading, at a device when data is changed, the changed data to a server, processing, at the server, the uploaded data, storing, at the server, the processed data along with a time change, transmitting, at the device, a synchronization request signal including a most recent server connection time at a predetermined time, downloading, at the device, a data log on data changed between the most recent server connection time and the current time, synchronizing, at the device, the data based on the data log, and updating the most recent server connection time.

In accordance with another aspect of the present invention, a data synchronization method of a device in a cloud server system including a server storing contents is provided. The method includes uploading, when data is changed, changed data, updating a most recent server connection time, transmitting a synchronization request signal including the most recent server connection time at a predetermined time, synchronizing data upon receipt of change information from a server in response to the synchronization request signal, and updating the most recent server connection time.

In accordance with another aspect of the present invention, a data synchronization method of a server in a cloud service system is provided. The method includes processing, when changed data is uploaded by a device, the changed data, storing the processed data with a time change, and transmitting, when a synchronization request signal is received from the device, a data log on the data changed between a most recent server connection time and the current time.

In accordance with another aspect of the present invention, a cloud service system is provided. The cloud service system includes plural devices which upload, when data is changed, changed data, transmit a synchronization request signal including a most recent server connection time at a predetermined time, synchronize data upon receipt of change information, and update the most recent server connection time, and a server which processes, when the changed data is uploaded, the changed data, stores the processed data along with a time change, and transmits, when the synchronization request signal is received, a data log on the data changed between the most recent server connection time of the device and the current time to the device.

### BRIEF DESCRIPTION OF THE DRAWINGS

The above aspects, features and advantages of the present invention will be more apparent from the following detailed description taken in conjunction with the accompanying drawings, in which:

FIG. 1 is a block diagram illustrating a configuration of the cloud service system to which the present invention is applied;

FIG. 2 is a block diagram illustrating a configuration of the device of the clouds service system according to an embodiment of present invention;

FIG. 3 is a flowchart illustrating a synchronization procedure between the server and the devices in the cloud service system according to an embodiment of the present invention;

FIG. 4 is a flowchart illustrating a synchronization procedure of the device in the cloud service system according to an embodiment of the present invention; and

FIG. 5 is a flowchart illustrating the synchronization procedure of the server in the cloud service system according to an embodiment of the present invention.

### DETAILED DESCRIPTION OF EMBODIMENTS OF THE PRESENT INVENTION

Embodiments of the present invention are described in detail with reference to the accompanying drawings. The same reference numbers are used throughout the drawings to refer to the same or like parts. Detailed description of well-known functions and structures incorporated herein may be omitted to avoid obscuring the subject matter of the present invention.

The present invention relates to an apparatus and method for synchronizing contents between a cloud server and at least one client device. That is, the server stores various contents, the client devices upload, when any content is created, modified, or deleted, the corresponding content to the cloud server, and the cloud server stores the uploaded content. Each client device may connect to the server at a predetermined interval or at a certain time, and the server acquires identity information on the updated contents between the previous connection time and the current connection time. In this way, the contents are synchronized between the cloud server and the individual client devices.

The cloud service system according to an embodiment of the present invention is capable of reducing an unnecessary amount of CPU operation of the client device by allowing the cloud server to perform most of the synchronization-related operations. The cloud service system according to an embodiment of the present invention is capable of minimizing the amount of data transmission between the cloud server and client devices through synchronization data history management and compaction, and thus reducing network traffic, resulting in minimization of battery power consumption.

In the following description, the term ‘cloud server’ is also referred to as ‘server’ and the term ‘client device’ is also referred to as ‘device’ and ‘terminal’ interchangeably.

The cloud service system according to an embodiment of the present invention is capable of minimizing terminal load especially when plural devices related to the same user request synchronization, and allows the server to perform the terminal's CPU-driven operations as much as possible. The cloud service system according to an embodiment of the present invention is capable of minimizing network traffic through synch data compaction.

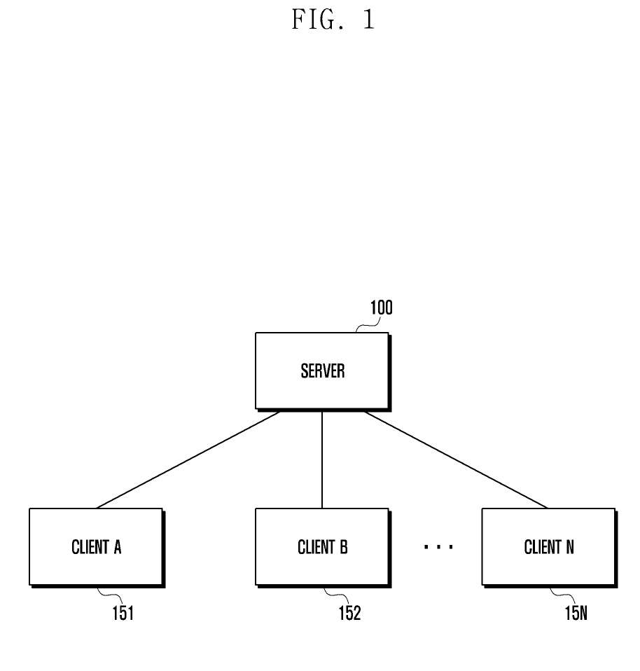

FIG. 1 is a diagram illustrating a configuration of the cloud service system to which the present invention is applied.

As shown in FIG. 1, the cloud service system includes a server 100 and at least one device 151, 152, and 15N. Here, the server 100 and the devices 151, 152, and 15N may be connected through wired or wireless links. The server 100 and the devices 151, 152, and 15N may be connected through the Internet or directly. In the following, the description is made under the assumption that the server 100 and the devices 151, 152, and 15N are connected wirelessly through the Internet.

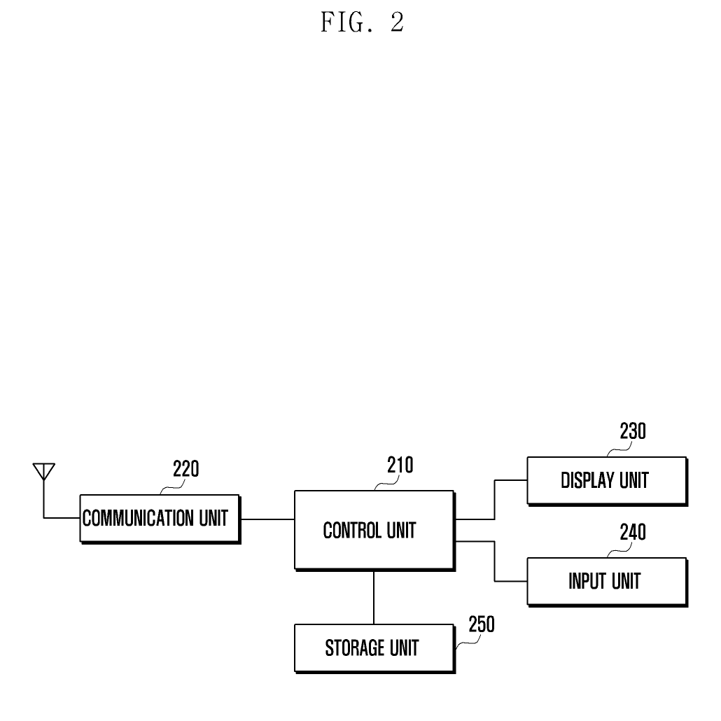

In this case, each of the client devices 151, 152, and 15N may be configured as shown in FIG. 2.

Referring to FIG. 2, the communication unit 220 is responsible for radio communication with a base station or another device. Here, the communication unit 220 may include a transmitter to up-convert and amplify the transmission signal and a receiver to low noise amplify and down-convert the received signal. The communication unit 220 may include a modulator and a demodulator. Here, the modulator modulates the transmission signal to output the modulation signal to the transmitter, and the demodulator demodulates the signal received by the receiver. In this case, the modulator/demodulator may be any of Long Term Evolution (LTE), Wideband Code Division Multiple Access (WCDMA), General System for Mobile (GSM), Wireless Fidelity (Wi-Fi), Wireless Broadband (WiBro), Near Field Communication (NFC), and Bluetooth. In an embodiment of the present invention, it is assumed that the communication unit 220 is provided with LTE, Wi-Fi, and Bluetooth communication modules.

The control unit 210 controls the overall operations of the device and performs synchronization of the contents between the server 100 and the corresponding device by uploading the contents, whenever they are modified, to the server 100. Here, if a content is modified, this means that the content is created, modified and/or deleted. The control unit 210 also controls the device to connect to the server 100 at a predetermined interval to detect any modification of the contents and receive modification information from the server 100, thereby synchronizing the contents between the server and the device.

The memory or storage unit 250 may include a program memory for storing the Operating System (OS) of the terminal and programs associated with the synchronization method according to an embodiment of the present invention, and a data memory for storing tables for use in the operations of the terminal, and application data generated by application programs.

The display unit 230 displays the content played under the control of the control unit 210. The display unit 230 may be implemented with one of a Liquid Crystal Display (LCD) and an Organic Light Emitting Display (OLED). The input unit 240 may be implemented with a touch panel and/or buttons (keys). When the input unit 240 is implemented with the touch panel, the input unit 240 and the display unit 230 may be integrated into a touchscreen 240.

The server 100 may include a communication unit identical with that of the devices 151, 152, and 15N and a database for synchronization by transmitting the contents uploaded from the devices 151, 152, and 15N back to the devices.

In the above-structured cloud service system, the plural devices 151, 152, and 15N of the same user uploads, when a file is created, updated (modified), or deleted, the corresponding file to the server 100. Then the server 100 synchronizes the files between the server 100 and the respective devices 151, 152, and 15N.

The devices 151, 152, and 15N send the server the most recent synchronization time to check whether there is any change since then. If there is no change since the most recent synchronization, the server ends the synchronization process and, otherwise if there is a change, receives a list of the changed contents as well as the changed contents themselves for synchronization and compaction. The devices 151, 152, and 15N may request synchronization by the server 100 at a predetermined interval or at a certain timing. Then the server 100 transmits the synchronized data log to the devices which have requested synchronization.

For example, if a new file is created at the device 151, the device 151 uploads the new file to the server 100. The devices 152 and 15N transmit the most recent synchronization times to the server 100 at the predetermined interval or at a certain time to check whether there is any change since the most recent synchronization times. If there is no change, the synchronization process ends. Otherwise, if there is a change, the devices 152 and 15N receive the list of the changed contents and download the corresponding contents for synchronization.

If the device 151 modifies the created file further before the devices 152 and 15N request synchronization by the server 100, the server 100 compacts the synchronization content using Tables 1 and 2. Table 1 shows the log compaction rule according to an embodiment of the present invention, and Table 2 shows a log compaction algorithm. In Table 1, W denotes a wrong operation sequence.

TABLE 1

prev(t)

| | | create | update | delete |
|---|---|---|---|---|
| [symbol] ext | create | W | W | W |
| ( [symbol] ti + 1) | | | | |
| | update | ti, ti + 1 | ti + 1 | W |
| | | (append) | | |
| | delete | delete | ti + 1 | W |

[symbol]

indicates data missing or illegible when filed

TABLE 2

```
      group-by Oid (object id), order by
time
      for each group, sliding window of
size 2
      apply compaction rule
```

Afterward, if the devices 152 and 15N request synchronization, the terminal 100 transmits only the compaction result such that the devices 152 and 15N download only necessary data (without unnecessary data), thereby improving synchronization efficiency between the server and the devices.

As described above, the content synchronization method according to an embodiment of the present invention operates based on the data log recording the modification history of the contents stored in the cloud. The data log may be classified into three types: ‘create’, ‘update’, and ‘delete’ according to the content modification characteristics However, the content synchronization method of the present invention may be embodied with more types of modification data. The server 100 stores the data log, and notifies the devices 151, 152, and 15N of the data log after the synchronization operation so as to minimize the load at the devices 151, 152, and 15N.

An embodiment of the present invention provides a data log compaction method in synchronizing contents between the server 100 and the devices 151, 152, and 15N. There may be unnecessary data for the devices 151, 152, and 15N among the data log stored in the server. In this case, if the server 100 transmits all the unnecessary data to the devices 151, 152, and 15N without filtering, this causes a degradation of the transmission efficiency of the server 100 and increases the load to be processed by the devices 151, 152, and 15N. Also, there is no need for storing the data log indefinitely for synchronization. If there is no entry by a new device, all the devices 151, 152, and 15N may securely delete the synchronized data log. Also, it may be more efficient to receive a list of the entire contents rather than synchronizing the contents using the data log after a predetermined time elapses. For example, a large part of the contents may be modified. For this reason, the server 100 stores the data log for a predetermined time according to the service level, calculates the duration necessary for synchronization in response to the request from the devices 151, 152, and 15N, and compacts the log of the corresponding duration using Tables 1 and 2, and sends the compacted log to the terminal.

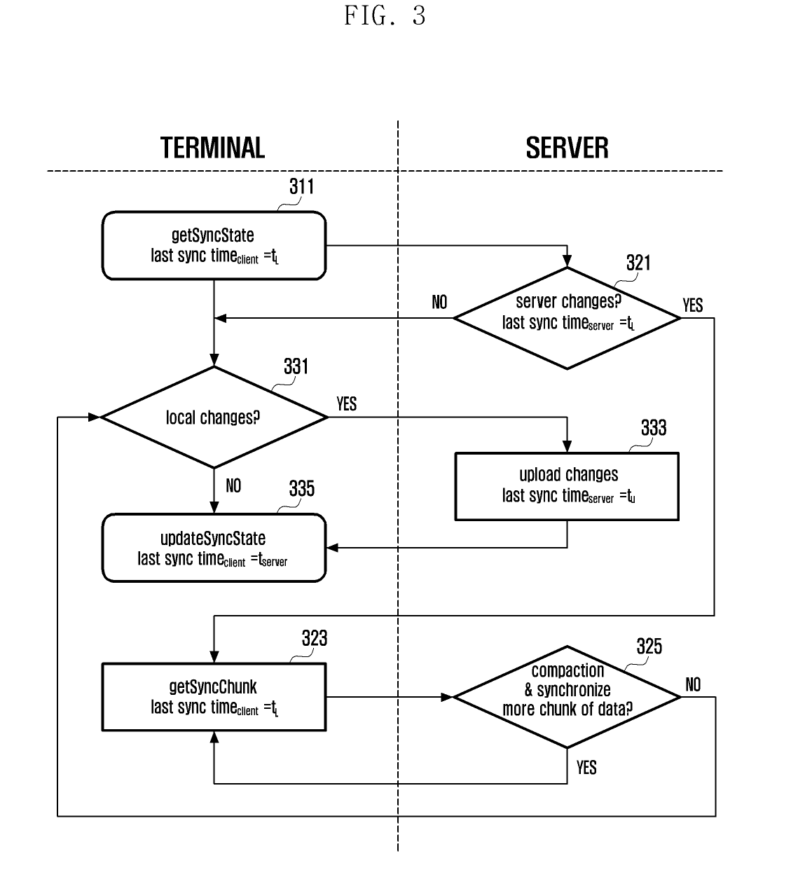

FIG. 3 is a flowchart illustrating a synchronization procedure between the server and the devices in the cloud service system according to an embodiment of the present invention.

Referring to FIG. 3, the device is in the synchronized state with the server at time t_{L} (getSyncState, last sync time_{client}=t_{L}) at step 311. In this state, the device transmits the information on the time of the last synchronization with the server (last sync time_{client}=t_{L}) to request synchronization by the server at a predetermined interval or at a certain timing. Then the server 100 receives the request and checks whether there is any change in the synchronization information (server change, last sync timeₛₑᵣᵥₑᵣ>t_{L}) since the last synchronization between the server and the device at step 321. That is, the server determines whether the data have changed by other devices since the last connection of the device which has requested synchronization at step 321. If there is a change, the server sends the identity information (Oid, Object id) of the changed data to the corresponding device. Then the device performs a synchronization operation based on the data change information downloaded from the server (getSyncChunk, last sync time_{client}=t_{L}) at step 323. At this time, the device and the server perform data synchronization through steps 323 and 325 and, at this time, the server compacts the unnecessary data and transmits, if there is more data to send, the data to the device (compaction & synchronization of more chunk).

That is, the device and server compact the log data in synchronizing the contents. As described above, if there is unnecessary data for the device among the stored log data, the server does not transmit the unnecessary data according to the compaction method. It is not necessary for the device to store the data log indefinitely, and if there is no entry by a new device, the synchronized data log may be removed. If a large amount of data is changed after the predetermined time has elapsed, it is more efficient to receive the list of the entire contents. Accordingly, at steps 323 and 325, the server stores the data log for a predetermined time duration according to the service level, calculates the time duration necessary for synchronization in response to a synchronization request from the device, compacts the log of the corresponding duration with Tables 1 and 2, and sends the compacted log to the device such that data synchronization is performed using the data log.

If there is any change in data, the device checks the change and uploads the changed data to the server at step 331. At this time, the change may be creation of new content, modification (edit) of the content, or deletion of the content. If the data are uploaded by the device, the server 100 processes the uploaded data and stores the change of the data in the database according to the result at step 333. The server 100 also stores the data change time (upload changes, last sync timeₛₑᵣᵥₑᵣ=t_{U}). After the upload according to the data change or if the data synchronization is not performed due to no data change in spite of the synchronization request with the server, the terminal checks this at step 331, ends the synchronization procedure, and updates the server connection time to the last connection time (updateSyncState, last sync time_{client}=tₛₑᵣᵥₑᵣ) at step 335.

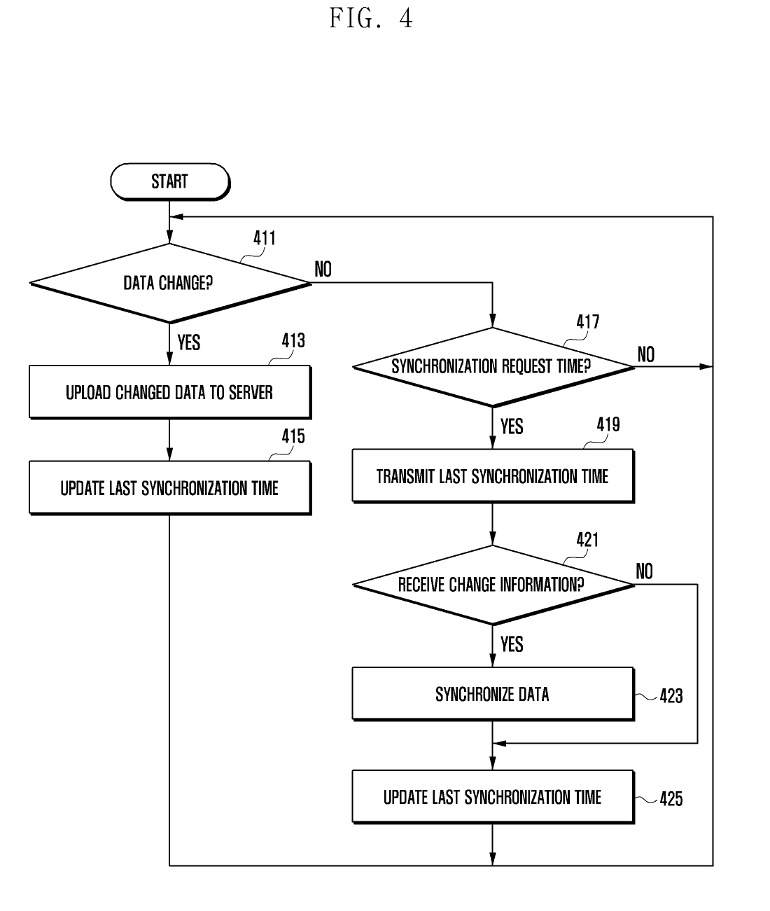

FIG. 4 is a flowchart illustrating a synchronization procedure of the device in the cloud service system according to an embodiment of the present invention.

Referring to FIG. 4, if it is necessary to upload data due to a change in data and if the periodic synchronization request occasion or a certain requested timing arrives or according to the user's request, the device requests connection to the server. Accordingly, if the data change (creation, edit (modification), deletion, etc.) is detected, the device detects this at step 411 and uploads the changed data to the server at step 413. The device updates the server connection time at step 415 with the most recent server connection time.

If there is no data change, but the synchronization request occasion arrives, the device detects this at step 417 and requests synchronization by the server by transmitting the most recent server connection time at step 419. If the change information is received from the server, the device receives the information (object id) of the changed content downloaded to perform synchronization at step 423 and stores the last server connection time as the most recent server connection time at step 425. Otherwise, if no change information is received from the server at step 421, the device does not perform synchronization and stores the server connection time as the most recent server connection time at step 425.

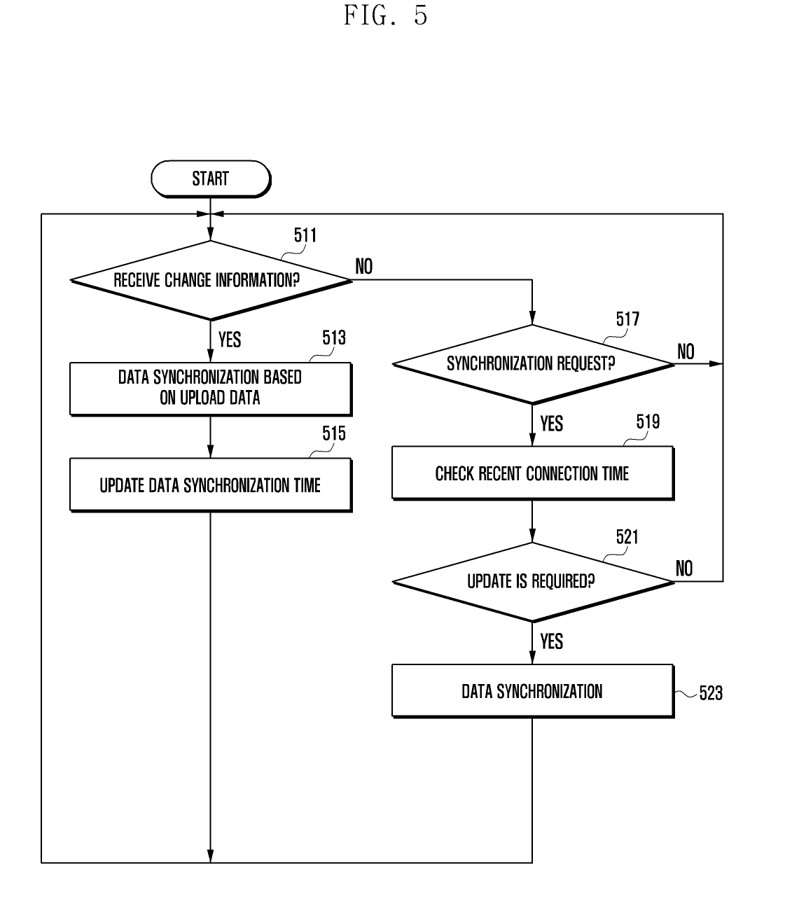

FIG. 5 is a flowchart illustrating the synchronization procedure of the server in the cloud service system according to an embodiment of the present invention.

Referring to FIG. 5, the server determines whether any changed data is uploaded from the device at step 511. If any changed data is uploaded from the device, the server synchronizes the corresponding data according to the uploaded data at step 513. At this time, the server performs the compaction process for removing data unnecessary to transmit to the terminal in the data synchronization procedure. That is, if the upload includes additional modifications in the state in which the data change has occurred, the server compacts the synchronization content according to the rules of Tables 1 and 2. Afterward, the server updates the data synchronization time at step 515.

If there is no data change, but the synchronization request is received from the device, the server detects this at step 517 and checks the most recent server connection time of the corresponding device at step 519. Afterward, the server checks the data change time and determines whether the data has changed between the most recent server connection time of the device and the current time at step 521. If the data has changed, the server detects this at step 521 and transmits the log data on the changed data to the corresponding device to perform data synchronization at step 523.

As described above, the server stores various contents, the devices upload, when any content is created, modified, or deleted, the corresponding content to the cloud server, and the server stores and processes the uploaded content. Each client device requests synchronization by the server at a predetermined interval or at a certain timing, and the server acquires identity information on the updated contents between the previous connection time and the current connection time. In this way, the contents are synchronized between the cloud server and the individual client devices.

At this time, since the server processes synchronization-related operations, the device is capable of reducing its operation time, resulting in reduction of power consumption and CPU operation. The server also manages and compacts the history of the data synchronization in the data synchronization procedure so as to optimize the traffic for synchronization between the server and the devices.

As described above, the content synchronization method and apparatus of the present invention is capable of allowing the cloud server to process most operations related to content synchronization so as to reduce unnecessary CPU operations of the client device and minimize the amount of data transmission through synchronization data history management and compaction, resulting in reduction of data traffic and battery power consumption. That is, the content synchronization method and apparatus of the present invention is capable of allowing the server to perform CPU-driven operations in response to a synchronization request and compact synchronization to minimize the network traffic in the cloud service system, resulting in the reduction of device load and battery power consumption.

Although embodiments of the invention have been described using specific terms, the specification and drawings are to be regarded in an illustrative rather than a restrictive sense in order to help understand the present invention. It is obvious to those skilled in the art that various modifications and changes can be made thereto without departing from the broader spirit and scope of the invention.

What is claimed is:

1. A synchronization method of a cloud service system, the method comprising:
uploading, at a device when data is changed, the changed data to a server;
processing, at the server, the uploaded data;
storing, at the server, the processed data along with a time change;
transmitting, at the device, a synchronization request signal including a most recent server connection time at a predetermined time;
downloading, at the device, a data log on data changed between the most recent server connection time and the current time;
synchronizing, at the device, the data based on the data log; and
updating the most recent server connection time.

2. A data synchronization method of a device in a cloud server system including a server storing contents, the method comprising:
uploading, when data is changed, changed data;
updating a most recent server connection time;
transmitting a synchronization request signal including the most recent server connection time at a predetermined time;
synchronizing data upon receipt of change information from the server in response to the synchronization request signal; and
updating the most recent server connection time.

3. A data synchronization method of a server in a cloud service system, the method comprising:
processing, when changed data is uploaded by a device, the changed data;
storing the processed data with a time change; and
transmitting, when a synchronization request signal is received from the device, a data log on the data changed between most recent server connection time and the current time.

4. A cloud service system comprising:
plural devices which upload, when data is changed, changed data, transmit a synchronization request signal including a most recent server connection time at a predetermined time, synchronize data upon receipt of change information, and update the most recent server connection time; and
a server which processes, when the changed data is uploaded, the changed data, stores the processed data along with a time change, and transmits, when the synchronization request signal is received, a data log on the data changed between the most recent server connection time of the device and the current time to the device.
